(19) United States
(12) Patent Application Publication
(10) Pub. No.: US 2005/0240555 A1
(43) Pub. Date: Oct. 27, 2005

(54) Interactive electronic technical manual system integrated with the system under test

(75) Inventors: Bruce Wilde, Vestal, NY (US); Matthew R. Liberty, Owego, NY (US); Michael N. Blackwell, Binghamton, NY (US); Richard Berbaum, Maine, NY (US); Edward R. Bestle, Owego, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation, Bethesda, MD (US)

(21) Appl. No.: 11/019,295

(22) Filed: Dec. 23, 2004

Related U.S. Application Data
(60) Provisional application No. 60/543,618, filed on Feb. 12, 2004.

(51) Int. Cl. G06F 7/00

(52) U.S. Cl. 707/1

(57) ABSTRACT

Disclosed is a Class V Interactive Electronic Technical Manual (IETM) that allows remote diagnostic engineers to interact directly with on-site maintenance technicians and a system under test. In addition, the disclosed IETM permits automatic synchronization of files on a maintenance technician's portable electronic display device. The disclosed IETM is also capable of dynamically displaying asset specific information and dynamically displaying technical information in multiple languages.

This application claims the benefit of U.S. Provisional Application No. 60/543,618, filed Feb. 12, 2004, which is incorporated herein by reference.

The present invention relates generally to diagnostics, and more particularly to interactive electronic technical manuals.

In the present invention, an Interactive Electronic Technical Manual (IETM) may provide dynamic diagnostics for a complex system. Examples of a complex system include aircraft, spacecraft, vehicles, mail distribution equipment, automobile factory systems, and/or the like. In general, any system made up of multiple components requiring diagnostics may be considered a complex system. For example, an exemplary Class V IETM of the present invention may permit system domain experts, such as diagnostic engineers, to directly interact with a remote maintenance technician. The Class V IETM of the present invention may also permit in-sync operation of the application software and underlying data, display of asset specific information, and the customization of the communication protocol with the System Under Test.

An Interactive Electronic Technical Manual (IETM), as defined in the Department of Defense IETM Specifications, is a package of information required for the diagnosis and maintenance of an electronic weapons system, optimally arranged and formatted for interactive screen presentation to the end-user maintenance technician. An IETM typically contains information required by technicians to perform on-site system maintenance. With an IETM, maintenance and troubleshooting procedures, parts information, theory of operation and illustrated graphics can be loaded on a lightweight portable computer to go where the technician goes.

The information in an IETM is designed and formatted for a screen presentation that enhances comprehension. The elements of technical data making up the technical manual are interrelated such that a user's access to information within the IETM is possible by a variety of paths. The computer-controlled IETM display device, or Portable Electronic Display Device (PEDD), typically a laptop computer, operates interactively to provide procedural guidance, navigational directions and supplemental information to the end-user maintenance technician. Powerful interactive troubleshooting procedures, not possible with paper technical manuals, can be made available using the intelligent features of the PEDD.

The Department of Defense generally recognizes several classes of an IETM ranging from simple non-indexed page images (Class 0) to an intelligent integrated database information system (Class V). By definition, a Class V IETM links directly to equipment and/or a maintenance network, integrates with equipment diagnostics and expedites troubleshooting, spares ordering and maintenance planning, thereby resulting in increased equipment availability. A Class V IETM provides “Dynamic Diagnostics” by allowing the IETM to directly communicate with System Under Test (SUT), which may be comprised of one or more subsystems. A subsystem may also be referred to herein as a Unit Under Test (UUT). In an exemplary system, the SUT may be comprised of a plurality of UUTs.

Creating an IETM for today's complex electronic systems has become more complicated as modern electronic systems are frequently designed using existing Commercial Off-The-Shelf (COTS) equipment and Modified Off-The-Shelf (MOTS) designed black boxes. This design method allows a system designer to utilize readily available hardware and software components that meet operational intent. In the present invention, a Class V IETM may communicate directly with the SUT through the Built-In-Test (BIT) capabilities of the COTS or MOTS System components.

A Class V IETM of the present invention provides “Dynamic Diagnostics” by interrogating the SUT based on XML-encoded “Diagnostic Fault Flows”. Diagnostic Fault Flows are described in more detail in co-pending application Ser. No. ______, which is hereby incorporated by reference. Diagnostic Fault Flows support interaction with the SUT and process the data returned from the BITs, thereby providing the ability to integrate the individual BIT results from the separate components. Thus, using the IETM of the present invention, the entire integrated system can thus be intelligently analyzed, not just individual components of the SUT. A Diagnostic Engineer associated with the development of the System typically designs the Diagnostic Fault Flows.

Diagnostic Fault Flows may comprise diagnostic logic needed to effectively detect and isolate faults. In a preferred embodiment, this logic is encoded in XML. Many fault detection and isolation tasks can be predefined and stored in an XML structure, however it is possible to create an ad hoc diagnostic procedure using XML.

The Class V IETM of the present invention provides for effective use of Diagnostic Fault Flows through an N-tier architecture. In an N-tier architecture, an application program is distributed into at least three distinct layers or “tiers” of operation. In a typical 3-tier application, the application user's computer (client tier) contains the programming that provides the graphical user interface and application-specific entry forms or interactive windows. The server tier includes a system level database and a program to manage access to it. The middleware tier is the communication “glue” between client and server layers. The middleware tier contains logic for acting as a server for client tier requests from application users. In turn, it determines what data is needed (and where it is located) and acts as a client in relation to the server tier.

Using the flexible N-tier architecture described herein, the Class V IETM of the present invention provides effective fault detection and isolation using automated interaction with the SUT. The IETM system of the present invention may include the ability for Diagnostic Engineers to interact directly with the IETM and indirectly with the SUT to assist the maintenance technician; the ability to synchronize files on maintenance technician's PEDD, providing for standalone, network centric or hybrid configurations; and/or the ability to display asset specific information.

### BRIEF DESCRIPTION OF THE DRAWINGS

As further discussed herein,

FIG. 1 illustrates one embodiment of an N-tier architecture of the present invention;

FIG. 2 illustrates how a maintenance technician communicates with external sources to get assistance in an IETM;

FIG. 3 illustrates how a remote Diagnostic Engineer is able to communicate with an IETM of the present invention in order to assist the maintenance technician;

FIG. 4 illustrates a standalone embodiment of the N-tier architecture of the present invention;

FIGS. 5A and 5B illustrate the XSL filtering used by the present invention to allow for dynamic version control;

FIG. 6 illustrates the XSL filtering used by present invention to allow for dynamic language customization of the IETM;

FIG. 7 illustrates the XSL filtering used by the present invention to allow for printing XML data in RTF format;

FIG. 8 illustrates the Communication Build process used to allow for multiple SUT communication modes; and

FIG. 9 illustrates the XSL filtering process used by the present invention.

### DETAILED DESCRIPTION

In one embodiment of the present invention, the system is deployed as a standalone program on the maintenance technician's PEDD. In this embodiment, all of the tiers (client, middleware and server) are distributed within the PEDD. In another embodiment, the client tier is distributed on the PEDD and the server tier is distributed on a network server. In this network-centric embodiment, many PEDDs could connect to the network server. The middleware tier can be distributed entirely on PEDDs, or the middleware tier may be logically distributed between a PEDD and a network server. Many different configurations will be apparent to one skilled in the art.

The server tier may be comprised of a database application. In a network-centric configuration, the database application is running on a network server supporting a plurality of PEDDs. The server tier does not necessarily have to run on a separate server computer, however. For example, in one embodiment, the server tier may be a separate software process executing on the same computer as the middleware tier.

The server tier database stores XML-encoded technical data used by the IETM; (i.e. Diagnostic Fault Flows, Manual Maintenance Procedures (e.g. Installation, Alignment, Cleaning, Remove & Replace)). These XML-encoded structures are stored by and accessed through the Server Tier database application.

All communication in the IETM of the present invention is routed through the middleware tier. The middleware tier of the present invention may be implemented using Java 2 Enterprise Environment (J2EE) servlet technology.

In a standalone configuration, the middleware tier is distributed on the PEDD, along with the server tier and the client tier. In a network-centric configuration, the middleware tier may reside on any computer in the network. As mentioned above, in one embodiment the middleware tier is logically distributed between a PEDD and a network server. In this embodiment, the middleware tier is logically divided into two components, one resident on a PEDD and one distributed on the network server. The PEDD resident component allows for “Remote Maintenance Assist HTML web access” and data/application synchronization on the PEDD. The server resident component allows for data/application synchronization on the database server back end.

The client tier may be implemented as a Java application operating on a maintenance technician's PEDD. In addition, the Java application includes a set of HTML web pages that may be accessed by geographically remote Diagnostic Engineers, discussed below.

From a hardware perspective, the PEDD plugs into the SUT. Inside of the SUT, an SUT interface provides basic diagnostic hooks into the SUT for access to raw BIT data from individual UUTs. The SUT interface provides access to UUT BIT capability and I/O testing. The inventive IETM application communicates and interrogates the SUT interface, and upon receipt of the data, interprets the individual UUT BIT data and/or a collection of multiple UUT BIT data according to the process encoded in the XML-encoded Diagnostic Fault Flows, thereby acting as a tool for supporting additional maintenance tasks.

The operation of the client tier application embeds the use of the middleware servlets to perform normal processing when responding to users/maintenance technician responses to posed questions.

### Remote Maintenance Assistance

While predefined Diagnostic Fault Flows contain many likely scenarios, not all permutations of BIT data responses, maintenance technician responses, IETM settings and System Configurations can be covered by the predefined Diagnostic Fault Flows. For example, during execution of a Diagnostic Fault Isolation Task, it is possible that a situation may be encountered wherein the pre-stored Diagnostic Fault Isolation Tasks cannot properly diagnose the problem. In these situations, the maintenance technician may require additional assistance to diagnose the problem.

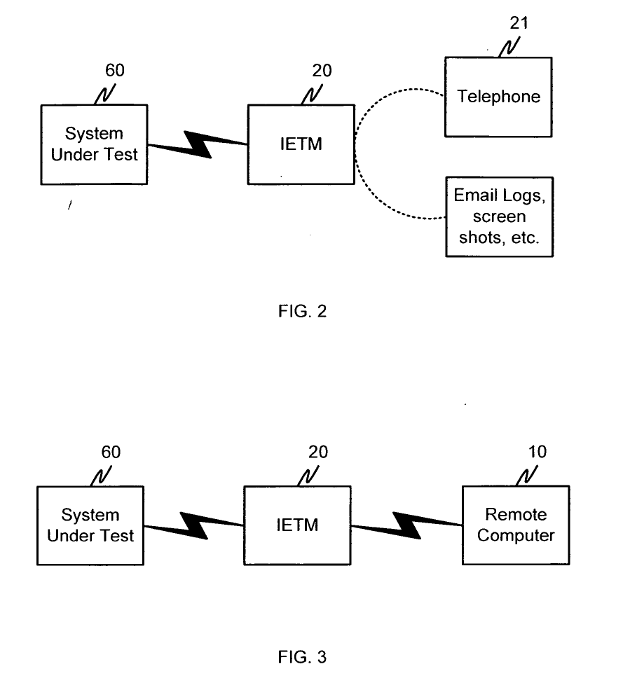

Before the IETM of the present invention, when an IETM being used by a maintenance technician could not properly diagnose a problem, the maintenance technician might contact a “Help Desk” or other source of technical assistance by telephone to walk through a problem. Alternatively or in addition to Help Desk assistance, the maintenance technician could email fault logs, capture screenshots, or send other information to technical assistance personnel. This is shown in FIG. 2, by SUT 60, standalone IETM 20 and communications 19 outside the IETM.

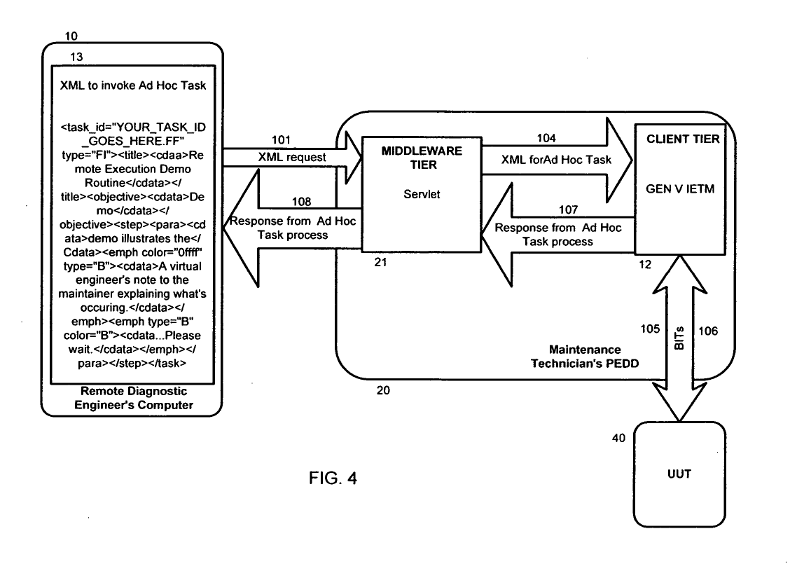

The present invention allows Diagnostic Engineers located remotely from the maintenance technician and the SUT to interact directly with the IETM, and thereby indirectly with the SUT, in order to assist the maintenance technician. FIG. 3 illustrates this direct connection between the remote Diagnostic Engineer 10 and the IETM application on the maintenance technician's PEDD 20. This Remote Maintenance Assistance feature of the IETM of the present invention is preferably implemented through the N-tier architecture described above.

From any networked location, the remote Diagnostic Engineer is able to communicate with the PEDD to perform diagnostic tasks on the SUT. These tasks are typically XML-encoded tasks that require the PEDD to communicate with the SUT. In one configuration of the inventive system that supports Remote Maintenance Assistance, the Diagnostic Engineer accesses a standard HTML webpage. The HTML webpage acts as part of the client tier, connecting to the PEDD's middleware tier. This access can be through a Java Servlet request, for example.

In a preferred embodiment, PEDD-based HTML pages can be accessed by the remote Diagnostic Engineer allowing nearly the same capabilities as the local maintenance technician. However, if a maintenance task requires the physical activation of a button, the local maintenance technician must perform that operation.

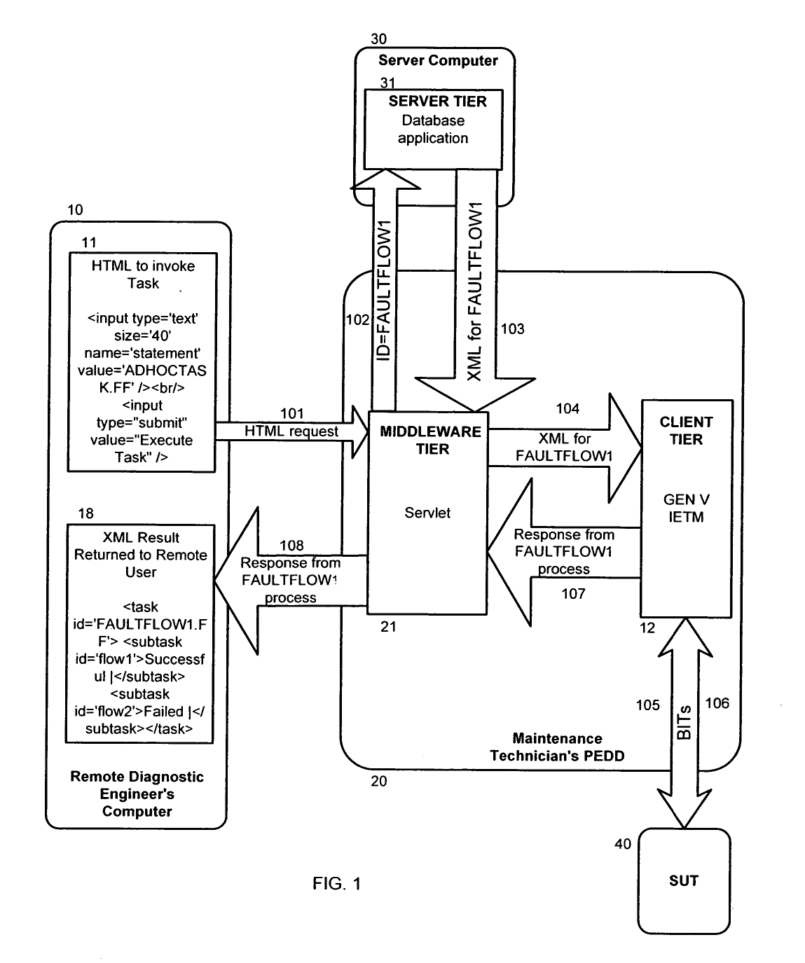

FIG. 1 shows an example of one embodiment of the IETM system of the present invention. In particular, the three tiers of the n-tier architecture of the present invention are a client tier 12, a middleware tier 21 and a server tier 31. In the example shown in FIG. 1, these three tiers are distributed between a network server 30 and maintenance technician's PEDD 20, and communicate with a remote Diagnostic Engineer's computer 10.

The diagnostic tasks requested by the remote Diagnostic Engineer may be predefined or they may be “ad hoc”. FIG. 1 illustrates the communication that occurs within the system when a remote Diagnostic Engineer requests a predefined, stored task to be performed by an IETM of the present invention.

In the example shown in FIG. 1, the Diagnostic Engineer uses his networked computer 10 to access a website and request a particular predefined task, “FAULTFLOW1”. The HTML that could be used to invoke the predefined “FAULTFLOW1” process stored in the server tier database is shown in block 11 of FIG. 1. “FAULTFLOW1” is the identifier used by the middleware tier and server tier to identify the database-resident task to be executed remotely.

Predefined tasks are stored in the server tier database. In order to gain access to the database of XML-encoded technical data, a normal HTTP request is made from the Client Tier to the Middleware Tier. This is shown in FIG. 1 as communication 101. The request is customized to request an external identifier (xrefid). The xrefid is the identifier of the database-resident task to be executed on the PEDD. In the example shown in FIG. 1, the xrefid is “FAULTFLOW1.FF”. The request may have optional parameters specifying a system design variant, and/or a language locale.

This HTML request is received by the Middleware Tier servlet 21 operating on the maintenance technician's PEDD 20. The Middleware Tier database servlet 21 gains access to the specified XML-encoded object contained with the Server Tier database by parsing the parameters of the Client Tier's HTTP request. In the example shown in FIG. 1, the servlet processes the request by requesting the XML-encoded task identified by the label “FAULTFLOW1” from the server tier database application 31 in communication 102.

The example shown in FIG. 1 illustrates a configuration in which Server Tier 31 is resident on a separate network server computer 30. It will be apparent to those skilled in the art that alternative configurations are possible. For instance, the server tier component, including the database of XML-encoded data, could be resident on the PEDD 20. In this configuration, the server tier software component and the middleware tier software component may operate as separate processes running on the PEDD.

The requested content is preferably forwarded to the appropriate middleware tier 21 control process via an internal TCP/IP socket in communication 103. During the processing, the optional parameters are parsed, which may result in additional constraints levied on the XML returned from the Server Tier database application 31. The XML-encoded data is preferably returned over HTTP to the Middleware Tier.

As shown in FIG. 1, the client tier application 12 on PEDD 20 receives the requested XML-encoded diagnostic process procedure 104 from the middleware tier 21 and initiates any requested diagnostic processes on the SUT 60 in communication 105. SUT 60 responds to the client tier 12 with the requested information in communication 106. The requested SUT procedures are typically BIT procedures, and the XML-encoded diagnostic process may contain multiple BIT procedures, so communications 105 and 106 may occur several times for a single process request. Communications 105 and 106 are specified by a configuration file and may use a standard hardware network connection, such as, for example, RS232, Ethernet, and/or the like, and a communications protocol, such as, for example, UDP/IP, TCP/IP and/or the like. However, it should be appreciated that communications 105 and 106 may be accomplished using any known or later developed elements capable of communicating data, including a wired or wireless element, and/or any known or later developed communications protocols suitable for implementing the communications 105 and 106 in accordance with the contemplated use of the present invention.

The middleware tier 21 waits for a response 107 from the client tier application 12 that indicates the results of the entire diagnostic process. This result is forwarded to the remote Diagnostic Engineer in communication 108. Communication 108 may have HTML content, or alternatively may be XML with a style sheet. FIG. 1 illustrates an example of XML results that may be returned. As shown by box 18, in this example the diagnostic process “FAULTFLOW1.FF” was successful, however subtask “flow2” within the diagnostic process FAULTFLOW1 failed.

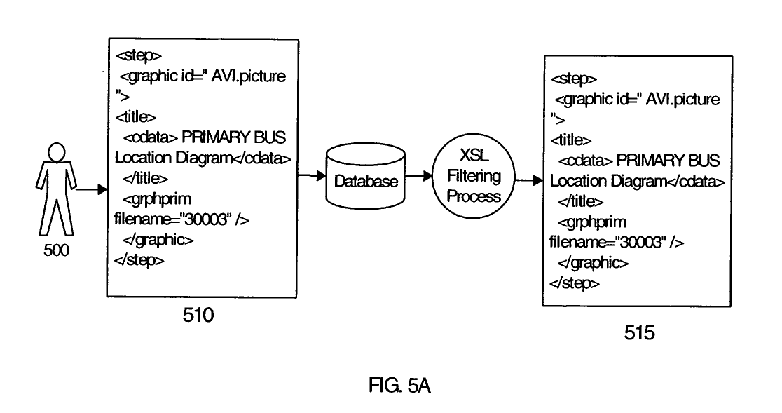

As mentioned above, the Remote Maintenance Assistance feature of the present invention may invoke a pre-stored task or an ad hoc task. When invoking a pre-stored task, the Middleware servlet interprets the HTTP request that includes the identifier of the database-resident task, as described above. In contrast, ad hoc tasks may be directly requested through well-formed XML that contains specific instructions to initiate the task to be executed remotely. FIG. 4 illustrates an example of ad hoc task processing. As shown in FIG. 4, the Middleware Tier servlet 21 processes the ad hoc request 13, forwards the processed content to the appropriate client tier control process 12 via an internal TCP/IP socket and waits for a response. In this ad hoc task-processing configuration, it may be possible that the system will not check XML syntax in a request, and it is therefore the Diagnostic Engineer's responsibility to ensure that the proper XML structure is adhered to.

### In-Sync Operation

IETMs are typically stand-alone applications that the maintenance technician uses during the execution of maintenance actions. The “standalone” operational restriction is typical for the operational environment where the emission of electronic communication is not allowed. IETM software and data are typically upgraded through distribution of a Compact Disk (CD) or Digital Video Disk (DVD) to ensure that there are no electronic signal emissions.

However, while not in the operational environment, it is possible for the IETM PEDD to be “docked” or connected to a network. When the IETM PEDD is docked, communications may occur through a wired connection. It is while the IETM has network connectivity that the Middleware Tier provides for synchronization of information reposed in the Server Tier's underlying database, or updates to the Client Tier application resident in the PEDD.

This “In-Sync” feature allows the IETM of the present invention to operate in multiple deployed scenarios, such as Standalone, Network-centric or Hybrid. In a Standalone configuration, the server tier software and the IETM XML data is stored locally on the maintenance technician's PEDD. In a Network-Centric configuration, the server tier software and the IETM XML data is located on a network server. In a Hybrid configuration, the server tier software and the IETM XML data is stored on both the network server and the PEDD. The hybrid configuration allows the maintenance technician to continue working even if the network is unreliable. The IETM of the present invention allows many different configurations and the flexibility to work in many different communications environments.

The In-Sync feature of the present invention allows for a hybrid configuration. The In-Sync feature ensures that local files on a PEDD are up-to-date and configured appropriately for the SUT.

To implement the “In Sync” feature, the servlets of the Middleware Tier are customized to move files from a remote location to the maintenance technician's PEDD upon request. The “In-Sync” process initiates a Web servlet on the maintenance technician's PEDD and indicates what files are to be copied from a remote machine. The servlet ensures that any downloaded files are copied to the correct location on the PEDD. Preferably, version information of downloaded files is also stored on the PEDD. Downloading updated files allows the IETM of the present invention to operate in the hybrid mode.

The In-Sync feature also allows for uploads. Uploads may be required when a customer or user requires a change, such as, for example, a change to the “look and feel” (e.g. style sheet updates), technical data (e.g. support files, manual XML data, diagnostic XML data, and/or the like), and/or support application upgrades (e.g. Adobe™ Acrobat™ reader software, Active CGM plug-in, and/or the like). The In-Sync feature may also initiate any needed special processing, such as placing a file in a certain location or indicating a system command to be performed.

The In-Sync operation is automated and customizable. Updates to the maintenance technician PEDD data and applications can be scheduled. For example, the system can check every time a PEDD is “docked” for any updates to be downloaded or uploaded. Alternatively, updates can be configured to occur on a cyclical schedule.

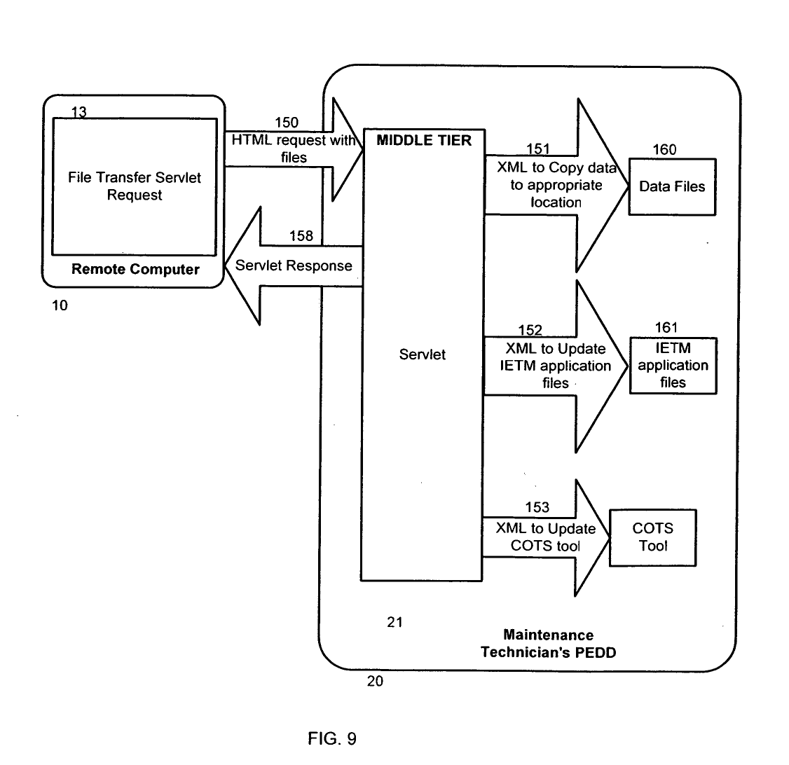

FIG. 9 illustrates the process that can be used to implement the In-Sync feature. As shown, a request is made on a machine 10 remote from the PEDD to either download or upload files from the PEDD. Remote machine 10 could be a Diagnostic Engineer's computer for example. Alternatively, remote machine 10 could be a network server.

Typically, there are three different types of files that are downloaded to a PEDD in a request. First, support files that assist in loading of the Server Tier database can be downloaded. Second, data files that are loaded into and managed by the Server Tier database can be downloaded. Third, application executable files can be downloaded. The request can be for a single file to be downloaded a single time, or the request can be part of an automated “bulk” update that contains many changes.

FIG. 9 illustrates how each of these types of updates can be implemented. As shown, if a data file, such as a new XML-encoded Diagnostic Fault Flow, is to be added to a local Server Tier database of a PEDD, this can be accomplished through block 151. If the IETM application executables are being updated to a new version, this can be accomplished through block 152. If a COTS or MOTS box needs to be updated, this is accomplished through block 153.

### Asset Specific Information Display

In the present invention data displayed by the application can be controlled dynamically. This allows the system to provide specific information to a maintenance technician for a particular design and/or specific modification to a particular asset in the SUT. In addition, this feature allows the support information to be displayed in multiple languages.

In one embodiment, this feature allows for version control of the IETM software and the data used by the IETM. For example, a SUT may contain many components that can potentially have many versions of interface software.

The present invention may use an eXtensible Stylesheet Language (XSL) filtering process to allow for dynamic visualization and filtering of data. XSL is a language for creating a stylesheet document that may transform and/or format XML data for presentation to a user. XSL gives a developer the tools to describe exactly which data fields in an XML file to display and exactly where and how to display them. An XSL translator takes XML and runs it through a specified stylesheet. The output from the stylesheet may be HTML, XML or text.

In the present invention, the manuals and technical data used in the Dynamic Diagnostics process are in the form of XML. By using an XSL filtering process, separate databases are not necessary to control version information. Keys can be used to identify each version's unique data. The XSL translation uses the key to only pull the data that is unique to that key. In addition, the XSL translation can pull data that does not have a key. This data is considered to be common to all versions.

Table 1 illustrates XML that could be used to identify a graphic that is common to all versions.

TABLE 1
Common XML

```
<step>
  <graphic id=”AVI.picture”>
    <title>
      <cdata> PRIMARY BUS Location Diagram
      </cdata>
    </title>
      <grphprim filename=”30003” />
  </graphic>
<step>
```

Table 2 illustrates an example that uses keys to identify a version 1 and a version 2 of the graphic. In this example, the key “applicsys” is used by the XSL during translation to identify the particular version of the graphic for that system.

TABLE 2
XML with Version History

```
<step>
  <graphic id=”AVI.picture”>
    <title>
      <cdata> PRIMARY BUS Location Diagram
      </cdata>
    </title>
      <grphprim applicsys=”Version 1” filename=”30003” />
      <grphprim applicsys=”Version 2” filename=”30003a” />
    </graphic>
<step>
```

Table 3 illustrates how the combined data is translated by the XSL filtering process of the present invention when “Version 2” is used as the translation key. The filtered data in Table 3 is presented to the user after the XSL filtering process filters out “Version 1” XML data.

TABLE 3
XML filtered through XSL translator

```
<step>
  <graphic id=”AVI.picture”>
    <title>
      <cdata> PRIMARY BUS Location Diagram
      </cdata>
    </title>
      <grphprim applicsys=”Version 2” filename=”30003a” />
  </graphic>
<step>
```

Common XML without a key (step and title in this example) are pulled, but only the grphprim with “Version 2” is displayed.

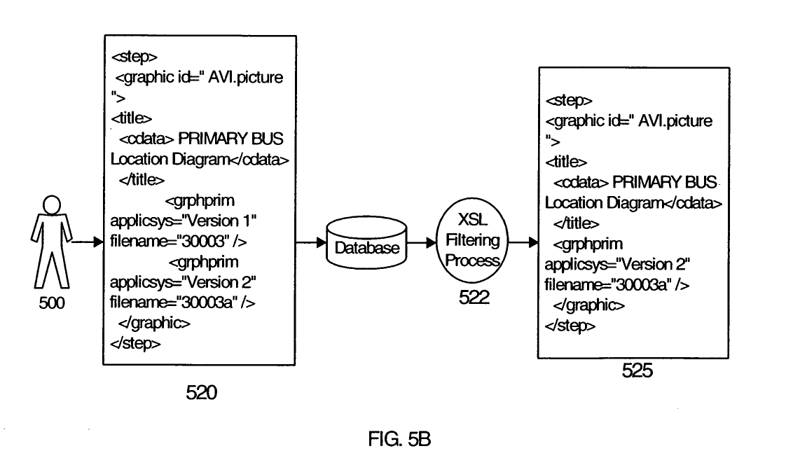

FIGS. 5A and 5B illustrates the XSL filtering process of the present invention. FIG. 5A illustrates the original XML data. As shown, the XML writer 500 writes the XML 510 to display the original documentation prior to any version changes. As shown by XML 515, the XML documentation is not filtered, and is displayed as written. FIG. 5B illustrates how the XSL filtering process can be used to filter changes to the XML such that only correct information for the current SUT is displayed. As shown in FIG. 5B, the XML 520 is updated to include version information. The XSL filtering process 522 includes the key “Version 2”. The XML after filtering 525 includes only XML for Version 2. If no key is used, all data requested would be received (i.e. both Version 1 and Version 2).

The XSL filtering process also allows for language filtering within an IETM. Instead of having multiple databases for each supported language and maintaining each database, one database can be used with keys to identify the desired language. A key similar to version control is used to perform XSL filtering for language. Each supported language has a key to identify the language within the XML. If the data does not contain a language key, it is considered common data and is shown in all languages.

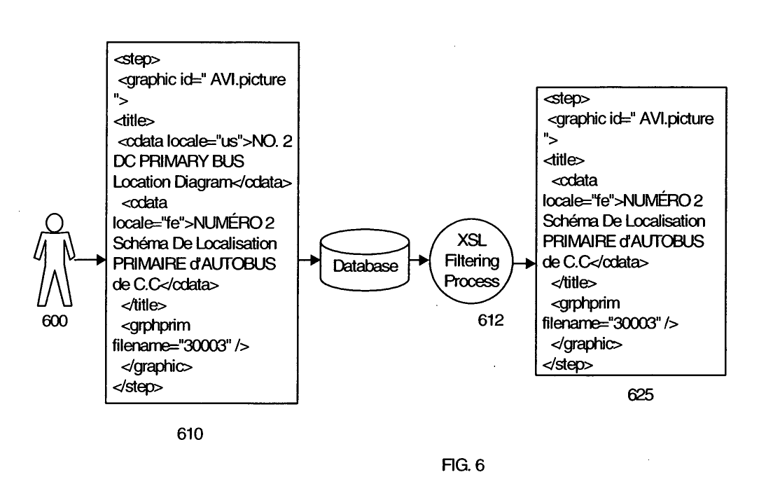

FIG. 6 illustrates Language Filtering for French. As shown, the XML writer 600 adds French text to the XML data 610, and uses the key “fe” for French and “us” for English. As shown by the filtered XML 625, the <cdata> tag for an English location has been removed from the presented data during the XSL filtering process 612.

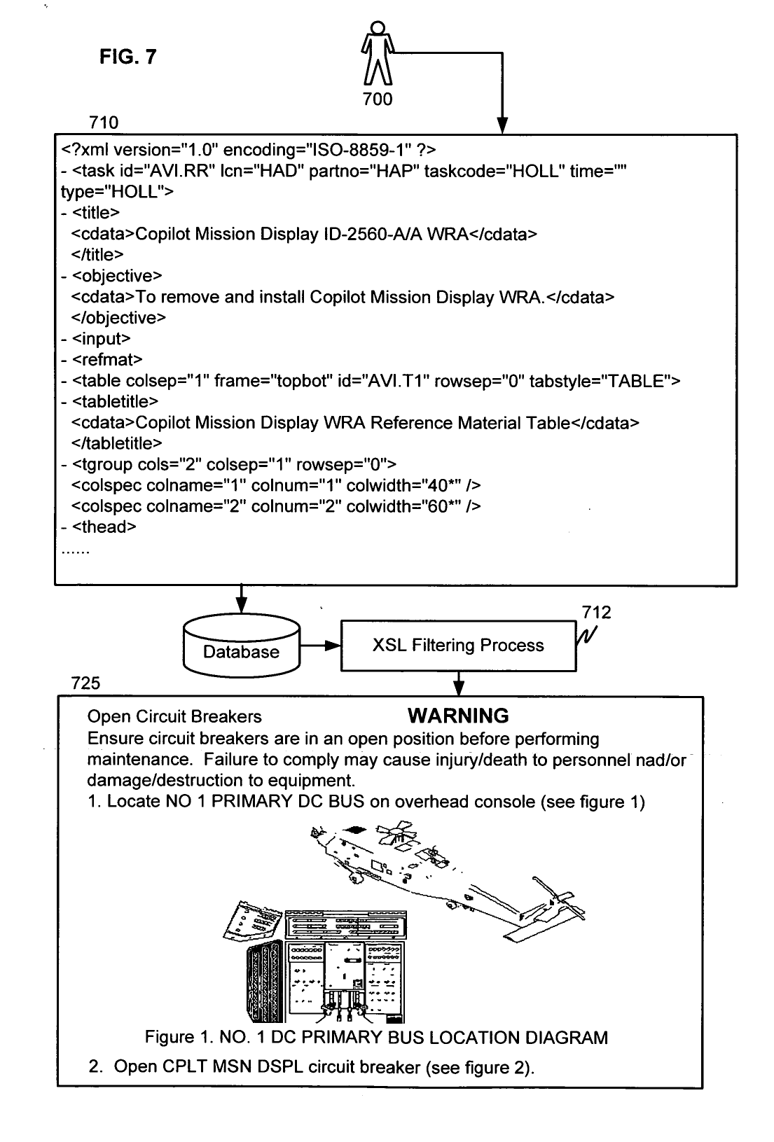

The XSL filtering process can also be used to translate the XML data into a RTF format. As shown by FIG. 7, the XSL filtering process 712 takes the XML 710 and uses an XSL stylesheet to encode the data into a presentable RTF file 725 that can be printed through any RTF viewer, such as Microsoft Word. This is a significant advantage as XML in its native format is not printer-friendly, as shown by 710.

SUT Communication

The present invention allows the IETM application to be extracted from the communication mechanism. In a preferred embodiment, Java class loader technology is used to start or load the communication mechanism called out in the configuration information. New communication technologies can be added without modifying the existing IETM application. In integrating a new communication mechanism, a new communication class is created by overriding the functionality of a pre-defined interface, included into a library extension, and referenced in the configuration information.

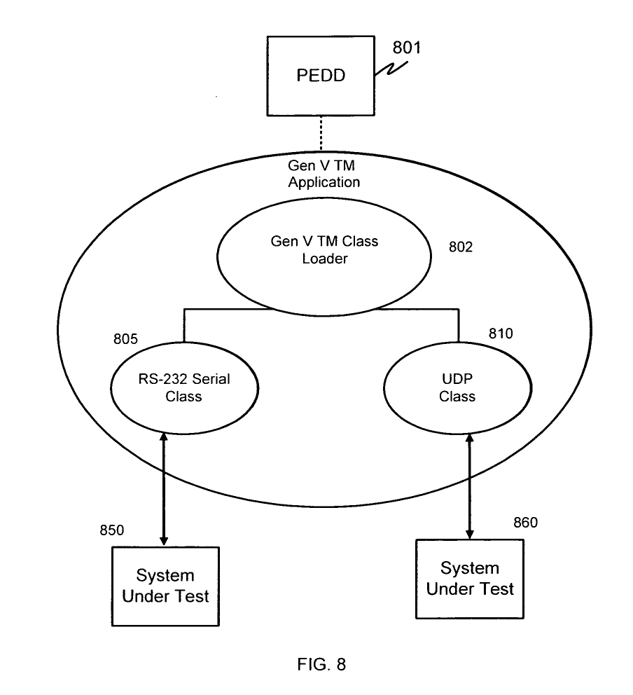

FIG. 8 illustrates how an IETM application can be loaded to use either RS-232 Serial Class communications or UDP class communications. As shown, JAVA class loader 802 can either load RS-232 Serial communication class 805 or UDP communication class 810, according to configuration data. This dynamic loading of classes upon the initiation of the IETM program allows for the easy addition of additional communication classes. The IETM supports multiple types of configuration files. For example, one type of configuration file is a user “look and feel” type, which is typically store locally on a PEDD data storage device, the second type of configuration file may be database resident and may contain pertinent information for performing communications to an SUT/JUUT, as well as other external applications, such as, for example, Simulators, Support Applications (for example Internet Explorer™, Adobe™ Acrobat™ Reader and Microsoft™ Word™) and/or the like.

Each product supported by an exemplary embodiment of a task processor in accordance with the present invention, such as, for example, a Generation V™ Task Processor has one or more associated “product configuration” files, which allow IT personnel to adapt the Generation V™ Task Processor to specific needs (requirements) of a customer. The adaptations for specific customer needs include the capability to specify the following:
the number, title and content of each “Table of Contents”;
the number, description, deterministic characteristics of unique task types. Also included here is the specific style sheet to be used during printing;
the number, description and programmatic steps for hyper linking within the application, allowing the easy customization to the customer's environment;
an initialization task;
a data connection customization task;
a quantity, description and location of log files;
a reference to a user-specific configuration task XML id;
a system interface;
a number, id and class name which implements the network protocols to be used in processing;
a number, id and class name which implements the information protocols to be used in processing;
a default IP address and port for initialization processing;
an SUT connection customization task to initialize PEDD-SUT interface variables;
Interface Control Message headers;
a name of the ICM;
a request header id;
a response header id;
an Interface Control Message Header Validation Test XML id;
an Interface Control Message Header Validation Failed XML id; PEDD-SUT Connection Indicator details;
a request header id and processing details; and
a response header id and processing details.

As shown in the above figures, an interactive electronic technical manual system integrated with the system under test in accordance with the present invention can be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions described herein can be used to implement an interactive electronic technical manual system integrated with the system under test according to this invention.

Furthermore, the disclosed system may be readily implemented in software using object or object-oriented software development environments that provide portable source code that can be used on a variety of computer platforms. Alternatively, the disclosed interactive electronic technical manual system integrated with the system under test may be implemented partially or fully in hardware using standard logic circuits or a VLSI design. Other hardware or software can be used to implement the systems in accordance with this invention depending on the speed and/or efficiency requirements of the systems, the particular function, and/or a particular software or hardware system, microprocessor, or microcomputer system being utilized. The interactive electronic technical manual system integrated with the system under test illustrated herein can readily be implemented in hardware and/or software using any known or later developed systems or structures, devices and/or software by those of ordinary skill in the applicable art from the functional description provided herein and with a general basic knowledge of the computer and mark-up language arts.

Moreover, the disclosed methods may be readily implemented in software executed on programmed general-purpose computer, a special purpose computer, a microprocessor, or the like. In these instances, the systems and methods of this invention can be implemented as program embedded on personal computer such as Java® or CGI script, as a resource residing on a server or graphics workstation, as a routine embedded in a dedicated encoding/decoding system, or the like. The system can also be implemented by physically incorporating the system and method into a software and/or hardware system, such as the hardware and software systems of an image processor.

It is, therefore, apparent that there is provided in accordance with the present invention, an interactive electronic technical manual system integrated with the system under test. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A method for dynamically displaying information about a system under test using an interactive electronic technical manual system, wherein said system under test is associated with at least one system key, comprising the steps of:
receiving mark-up language data at the interactive electronic technical manual system, wherein a portion of said mark-up language data includes at least one translation key, said at least one translation key corresponding to a system key associated with the system under test;
filtering the mark-up language data using a stylesheet to provide filtered mark-up language data; and
displaying the filtered mark-up language data by the interactive electronic technical manual system;
wherein the stylesheet is configured to filter the mark-up language data by comparing a value of each translation key with a value of the system key that corresponds to the translation key, and removing any mark-up language data whose translation key value does not match the value of the corresponding system key.

2. The method of claim 1, wherein at least one system key comprises a version identifier.

3. The method of claim 1, wherein at least one system key comprises a language identifier.

4. The method of claim 1, wherein at least a portion of the mark-up language data received by the interactive electronic technical manual system comprises of data that does not include a translation key, wherein said data that does not include a translation key is not filtered out by the stylesheet.

5. The method of claim 1, wherein said stylesheet is additionally configured to filter the mark-up language data by encoding the mark-up language data into a rich text format file viewable by a rich text format viewer.

6. The method of claim 1, further comprising the step of using a class loader to load a communication mechanism identified by a translation key in the mark-up language data.

7. A stylesheet for an interactive electronic technical manual comprising:
software instructions for enabling a computer to perform predetermined operations; and
a computer readable medium bearing the software instructions;
the predetermined operations including the steps of:
filtering mark-up language data displayed by an interactive electronic technical manual connected to a system under test, said mark-up language data comprising at least one translation key, said at least one translation key corresponding to a system key in the system under test, wherein said stylesheet filters mark-up language data by comparing a value for each system key with a value for the translation key corresponding to each system key.

8. The stylesheet of claim 7, wherein at least one system key is a version identifier.

9. The stylesheet of claim 7, wherein at least one system key is a language identifier.

10. The stylesheet of claim 7, wherein at least one system key is a communication mechanism class identifier.

11. The stylesheet of claim 7, additionally configured to transform the mark-up language data by encoding the mark-up language data into a rich text format file viewable by a rich text format viewer.

12. An interactive electronic technical manual system for diagnosing faults in a complex system, comprising:
a client tier component, wherein the client tier component is configured to interface with the complex system according to a mark-up language encoded diagnostic fault flow;
a middleware tier component, wherein the middleware tier component is configured to receive a request for execution of a diagnostic fault flow from a remote computer and to cause the client tier component to execute the requested diagnostic fault flow; and
a server tier component comprising a database, said database storing mark-up language encoded diagnostic fault flows.

13. The system of claim 12, wherein said request for execution of a diagnostic fault flow comprises a diagnostic fault flow identifier, and said middleware tier component is configured to request a mark-up language encoded diagnostic fault flow from the server tier component database corresponding to the diagnostic fault flow identifier, and to cause the client tier component to execute the mark-up language encoded diagnostic fault flow that corresponds to the diagnostic fault flow identifier.

14. The system of claim 13, wherein the mark-up language encoded diagnostic fault flow corresponding to the diagnostic fault flow identifier is sent from the server tier component as an object access protocol message to the middleware tier component.

15. The system of claim 12, wherein said request for execution of a diagnostic fault flow comprises a mark-up language encoded diagnostic fault flow process, and said middleware tier component is configured to cause the client tier component to execute the mark-up language encoded diagnostic fault flow process in said request.

16. The system of claim 12, wherein said client tier component is configured to interface with the complex electronic system by requesting execution of a built-in-test and receiving the results of the requested built-in-test.

17. The system of claim 12, wherein the server tier component is distributed on a network server computer and the client tier component is distributed on a portable electronic display device.

18. The system of claim 17, wherein the middleware tier component is logically distributed between the network server computer and the portable electronic display device.

19. The system of claim 12, wherein the server tier component, the middleware tier component and the client tier component are each distributed on a portable electronic display device.

20. The system of claim 12, wherein the client tier component is a Java application.

21. The system of claim 12, wherein a remote user requests execution of a diagnostic fault flow through an HTML interface on the remote computer.

22. The system of claim 12, wherein the server tier component is stored on both a network server computer and a portable electronic display device, and wherein the middleware tier component synchronizes the server tier component database on the portable electronic display device with the server tier component database on the network server by copying files from the network server to the portable electronic display device when the portable electronic display device is connected to the network server over a network.

23. The system of claim 22, wherein file version information is copied to the portable electronic display device when files are copied to the portable electronic display device.

24. The system of claim 22, wherein files copied from the network server to the portable electronic display device include both executable files and data files.

25. The system of claim 12, wherein the complex system is a helicopter.

26. An interactive electronic technical manual system for diagnosing faults in an aircraft, comprising:
a client tier component, wherein the client tier component is configured to interface with the aircraft according to a mark-up language encoded diagnostic fault flow;
a middleware tier component, wherein the middleware tier component is configured to receive a request for execution of a diagnostic fault flow from a remote computer and to cause the client tier component to execute the requested diagnostic fault flow; and
a server tier component comprising a database, said database storing mark-up language encoded diagnostic fault flows.

27. The system of claim 26, wherein the aircraft is a helicopter.
